(19) United States
(12) Patent Application Publication
(10) Pub. No.: US 2010/0141022 A1
(43) Pub. Date: Jun. 10, 2010

(54) Composite Wheel with Reinforced Core

(76) Inventors: Tomer Hendel, Santa Monica, CA (US); Guy Hendel, Santa Monica, CA (US)

Correspondence Address: THE MUELLER LAW OFFICE, P.C., 12951 Harwick Lane, San Diego, CA, 92130, US

(21) Appl. No.: 12/582,709

(22) Filed: Oct. 21, 2009

Related U.S. Application Data
(63) Continuation-in-part of application No. 12/315,595, filed on Dec. 4, 2008.

(51) Int. Cl. B60B 5/02; B21D 53/26

(52) U.S. Cl. 301/64.703; 29/894.3

(57) ABSTRACT

A design and method for making a one-piece composite wheel with a reinforced core is disclosed. The composite wheel incorporates a disc core embedded in the disc region and an optional rim core embedded in the rim region. The material for the core pieces may be a honeycomb structure that is reinforced in three dimensions. The disc and rim of the composite wheel are formed integrally as one piece, such as by resin infusion molding.

### RELATED APPLICATIONS

This application is a continuation-in-part of U.S. patent application Ser. No. 12/315,595 filed Dec. 4, 2008, entitled “Composite Wheel With 3-Dimensional Core” which is hereby incorporated by reference for all purposes.

### BACKGROUND OF THE DISCLOSURE

The present invention relates to the design and manufacture of a composite wheel. Composite materials have been utilized for their advantage of being lighter in weight than conventional metal wheels. However, to obtain strengths comparable to that of metal wheels, the required thickness of a composite wheel may negate the weight advantage of the material. As such, the ability to increase the strength of composite materials through the use of various resins, fibers, and configurations of laying out the fibers has been one area of development in the field of composite wheels.

In addition, manufacturing processes to make composite wheels cost-effective to produce is another area of development. Composite wheels are typically made from two main pieces. For example, the wheel may be split vertically so that a first piece (e.g., “street side” half) is joined to a second piece (e.g., “drum side” half). In other examples, the wheel is made of a central disc portion joined to a second rim or ring piece forming the circumference of the wheel. Two-piece wheels may be joined, for example, by metal bolts and adhesives, and may require the use of additional components such as sleeves and collars to assist in aligning and securing the parts together.

There remains a continued need for lightweight, composite wheels with increased strength and improved manufacturability.

### SUMMARY OF THE DISCLOSURE

The present disclosure describes a one-piece composite wheel with a three-dimensionally reinforced honeycomb core embedded in the disc. Additionally, a reinforced honeycomb core may optionally be embedded in the rim of the wheel. In some embodiments, the disc core and rim core are integral to each other. The honeycomb core is an isotropic structure that offers high strength in all three dimensions rather than just in one dimension as in traditional honeycomb structures. The core may be constructed from, for example, aluminum.

The one-piece composite wheel may be formed by an infusion process. In one embodiment, a core piece for the disc is sandwiched between layers of composite fiber, such as carbon fiber, within a mold. Additional composite fiber is layered around the sandwich, optionally with a second core piece placed inside the rim area. Resin is infused into the mold, thus integrally forming the rim and the disc together as a one-piece wheel.

### BRIEF DESCRIPTION OF THE DRAWINGS

Reference now will be made in detail to embodiments of the disclosed invention, one or more examples of which are illustrated in the accompanying drawings.

FIG. 1 illustrates a perspective view of an embodiment of the present invention;

FIG. 2 is a front view of the wheel of FIG. 1;

FIG. 3 is a side view of the wheel of FIG. 1;

FIG. 4 depicts a perspective view of an exemplary disc core of the present invention;

FIG. 5 provides a detailed perspective view of an exemplary reinforced honeycomb structure;

FIG. 6A illustrates a cross-sectional view of one embodiment of a wheel of the present invention;

FIG. 6B provides a detailed view of section A of FIG. 6A;

FIG. 7 is an exploded perspective view of an exemplary mold; and

FIG. 8 illustrates is a perspective view of an exemplary manufacturing apparatus.

### DETAILED DESCRIPTION OF THE EMBODIMENTS

Composite materials have been used in wheels as a means to decrease weight and consequently improve performance. The present disclosure describes a one-piece composite wheel having a reinforced core. The reinforced core advantageously reduces weight while improving strength. The one-piece design offers the ability to decrease manufacturing cost at mass production levels through reducing the number of parts compared to composite wheels known in the art.

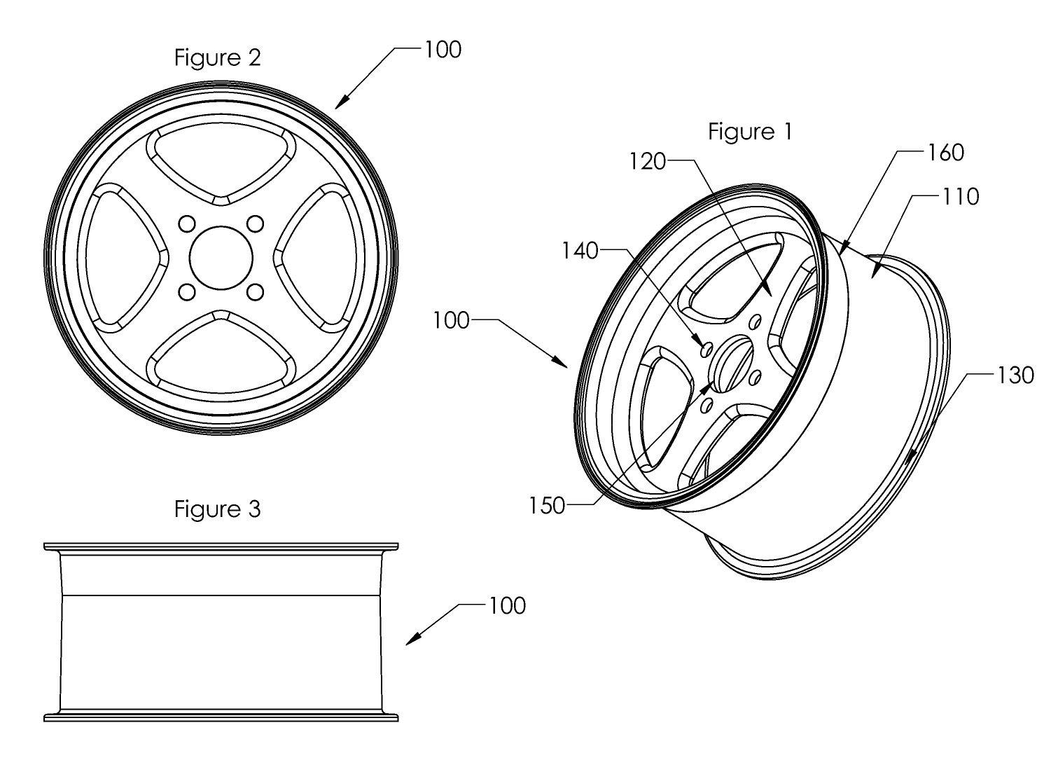

FIGS. 1, 2, and 3 illustrate perspective, front, and side views respectively of an exemplary wheel 100 of the present invention. FIG. 1 describes various portions of the wheel 100, including rim 110, disc 120, bead seat 130, lug nut holes 140, axle hole 150, and drop center 160. Rim 110 is the portion of the wheel to which a tire is mounted, and includes bead seat 130 around the outer ring portion of rim 110, and drop center 160. While drop center 160 is illustrated in FIGS. 1 and 3 as relatively level with the rest of rim 110, drop center 160 may also be recessed as known in the art to assist with tire mounting and to reduce weight. Disc 120 is the central portion of wheel 100 that enables the wheel 100 to be mounted onto a vehicle via lug nut holes 140 and axle hole 150 in the hub section. Note that the shape of disc 120 throughout this disclosure is merely representative of the possible shapes. For example, disc 120 may have more or less than the four spokes shown, may be a solid circular plate, or may have a different number of lug nut holes 140 and with alternate placing than what is shown. As shall be described subsequently in relation to manufacturing processes, rim 110 and disc 120 are formed integrally as one piece with an embedded disc core. Such a one-piece construction beneficially offers reduction of manufacturing costs at mass production levels by reducing the need for fasteners, sleeves, or other components as are required with two-piece wheel designs.

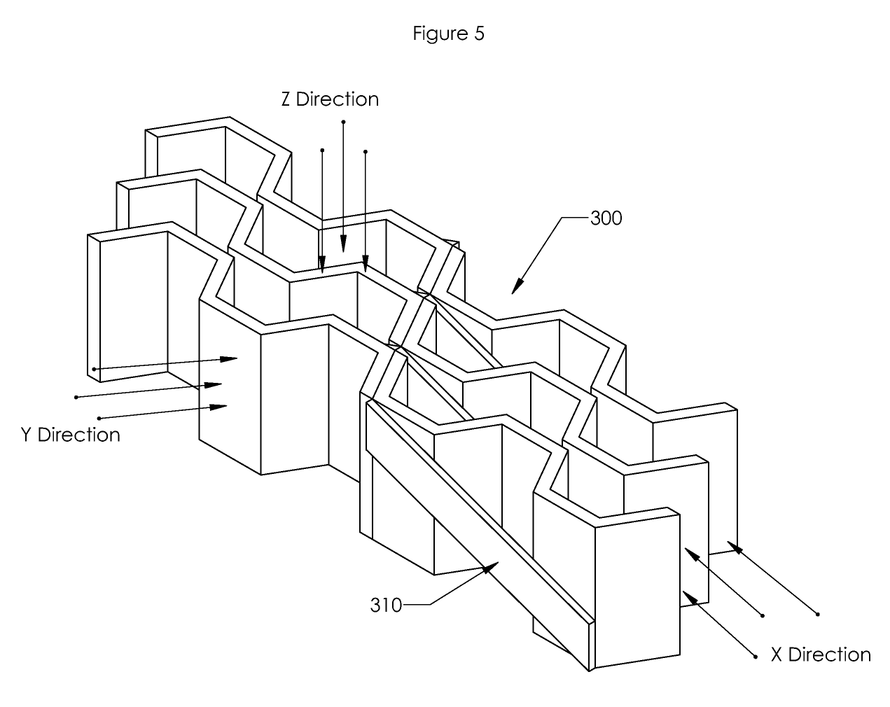

FIG. 4 illustrates an exemplary disc core 200 for embedding within the composite wheel 100 of FIG. 1. Wheel 100 is fabricated from a composite material, such as but not limited to carbon fiber, fiberglass, or aramid fibers layered around the disc core 200. Disc core 200 is constructed from a three-dimensionally reinforced material, which advantageously offers improved wheel strength while reducing weight. The shape of disc core 200 corresponds to the shape and features of disc 120, such as the spokes 210 and lug nut holes 220 in the hub area. Disc core 200 may be machined into shape by, for example, water jet cutting and conventional machining methods. Specific dimensions of disc core 200 relative to the overall dimensions of disc 120 are based on the strengths and properties of the particular materials used (e.g., core, composite fiber and resin) as well as on the specific wheel design. Dimensions may be calculated using finite element modeling or other appropriate analysis methods known in the art. The overall size of disc core 200 depends on the specific application, but may in typical scenarios vary from three inches in diameter to larger than ten feet, as could be the case in heavy construction equipment applications. However, there are no size limitations except as required by a particular application. The thickness of a three-dimensional honeycomb core varies similarly based on the particular application, with a sample range encompassing 1/16^{th} of an inch to several feet.

FIG. 5 provides detailed structure of an exemplary reinforced material 300 for disc core 200. In the embodiment of FIG. 5, material 300 is a honeycomb-type structure reinforced in three dimensions. While a standard honeycomb offers resistance in the Z-direction, the reinforced honeycomb structure of FIG. 5 incorporates cross-beams 310 which provide load resistance in the X- and Y-directions. Such an isotropic structural material embedded within the wheel 100 adds strength and stiffness with a minimum of increased weight. Other honeycomb-type structures that are reinforced in three dimensions may also be used as a core material. In one embodiment, the disc core 200 may be made of Trussgrid™ three-dimensional honeycomb material and may be aluminum. In other embodiments, the disc core 200 may be made from titanium, plastic, wood, foam, or any material with sufficient strength and weight advantage.

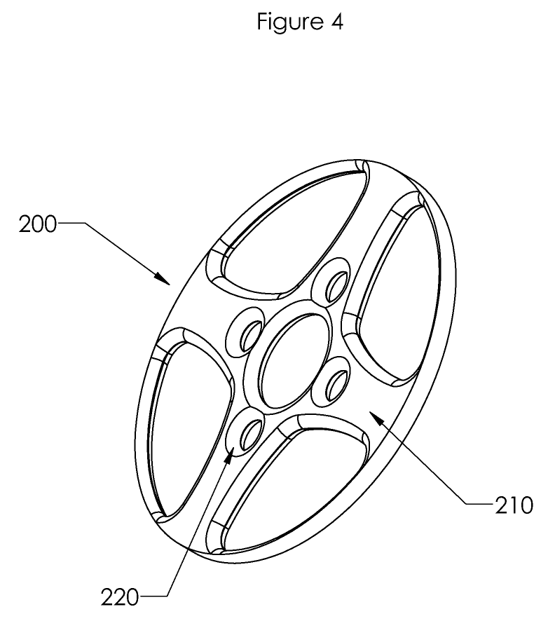

Returning to FIG. 2, optional lug nut inserts (not shown) to prevent crushing of the core material may be inserted into lug nut holes 220, such as directly onto the disc core 200 during layering with composite material, or onto the finished wheel. Lug nut inserts may be made of, for example, aluminum, steel, or fiberglass laminate, and may be embedded in or bonded to the wheel. Similarly, inserts for axle hole 150 of FIG. 1 may also be utilized.

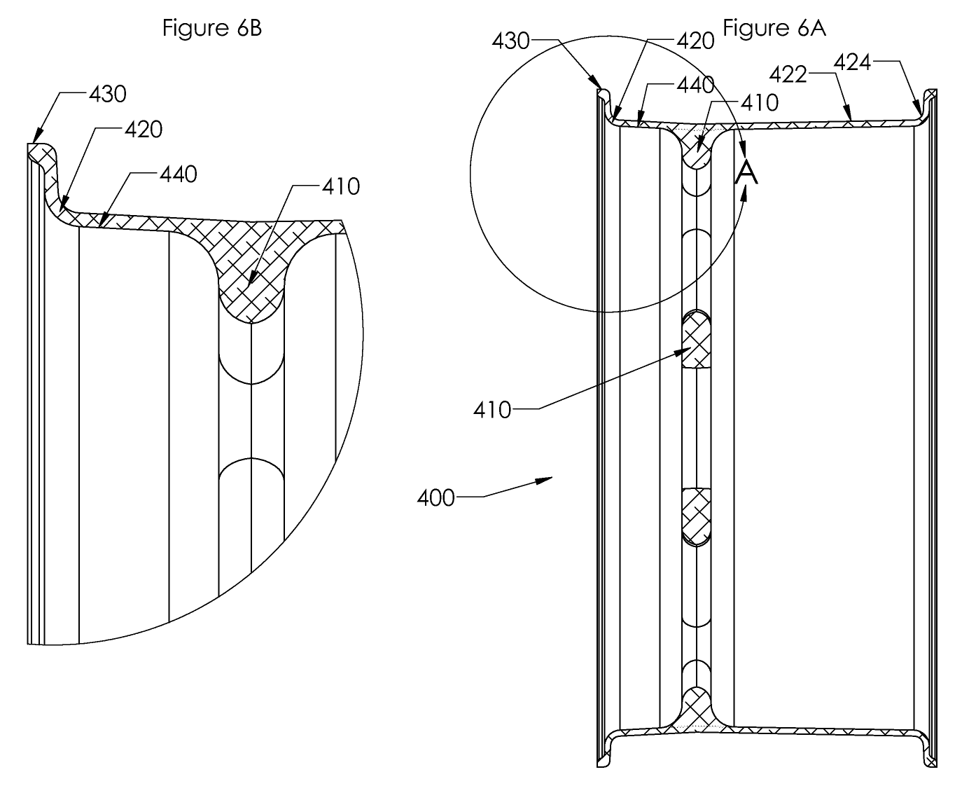

In addition to an embedded disc core 200, the wheel of the present invention may optionally include an embedded rim core. A rim core may further reduce the weight of the wheel by replacing layers of composite fiber. FIG. 6A depicts a cross-section taken vertically through a non-spoke diameter of an exemplary wheel 400. In FIG. 6A both a disc core 410 and a rim core 420 can be seen, and disc core 410 and rim core 420 are one integral piece. The integral disc core 410 and rim core 420 may be placed in a mold and then layered with fibers over it. In other embodiments, disc core 410 may be a separate piece from rim core 420, and the core pieces may each be layered with fiber individually or together as one unit. For example, the disc core may be wrapped with carbon fiber, then more carbon fiber layers may be overlapped on the rim section, and then the rim core placed around the assembly and applied with additional carbon fiber to form outer layers of the wheel. In yet other embodiments, rim core 420 itself may be comprised of individual components. For instance, rim core 420 may include one piece for the flat rim area 422 and another piece within the bead seat area 424. FIG. 6B provides a close-up view of section A in FIG. 6A. Reference numbers 430 and 440 identify outer and inner composite material, respectively, layered around rim core 420. Although not shown in detail, disc core 410 is similarly embedded between inner and outer layers of composite material, such as a fiber-reinforced resin.

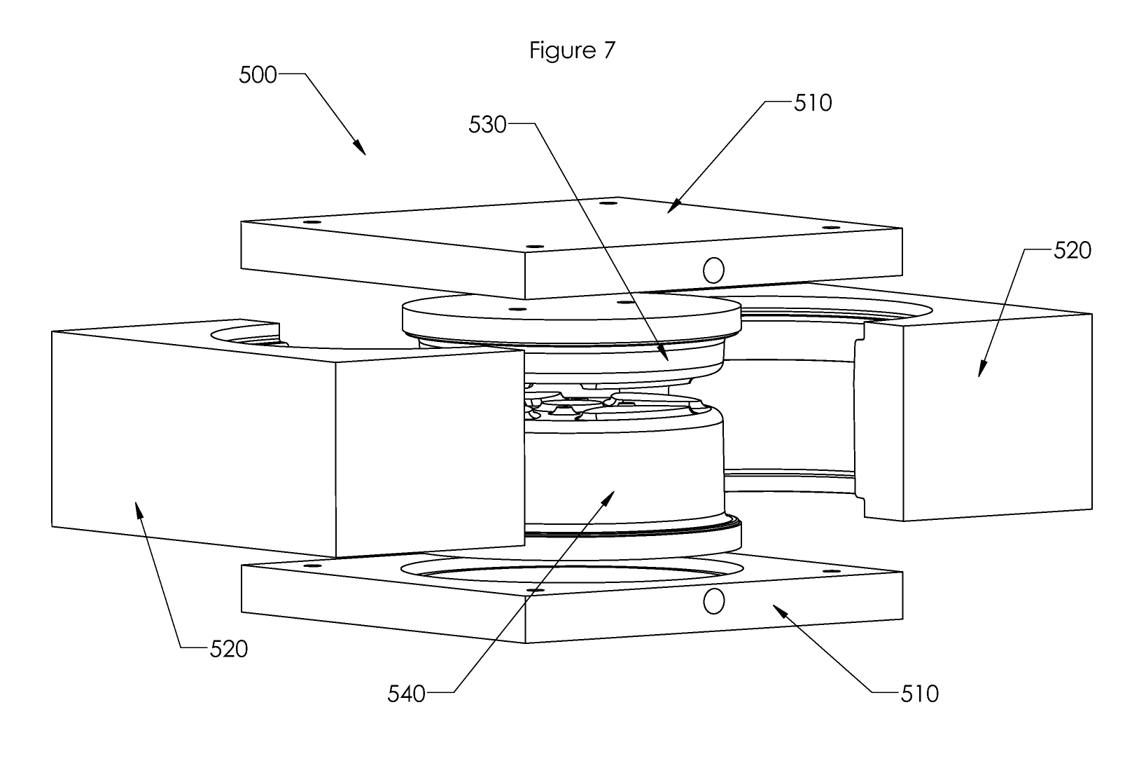

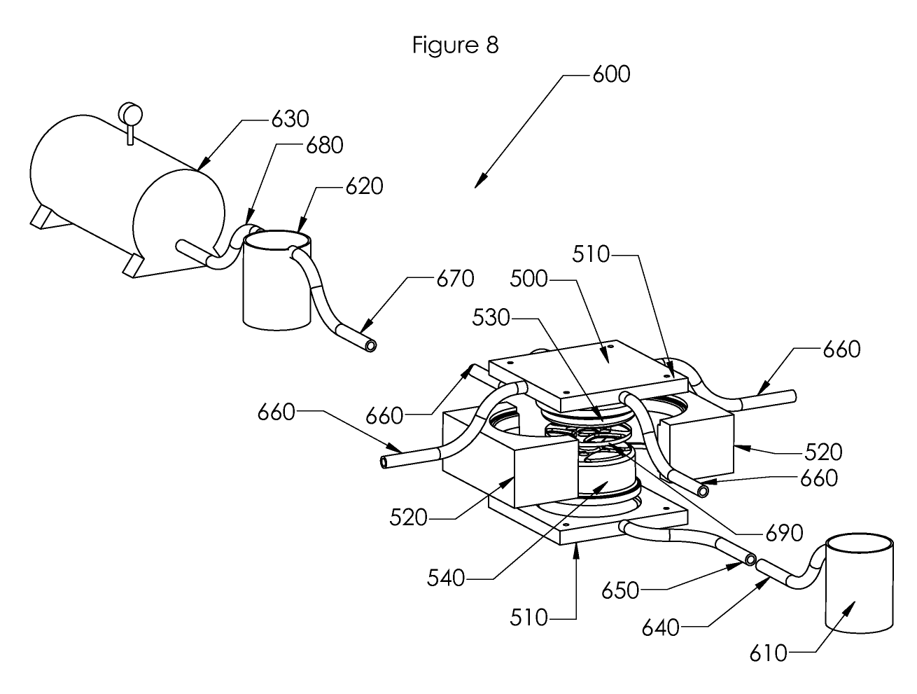

FIGS. 7 and 8 depict exemplary methods of forming a composite wheel of the present invention. In FIG. 7, an embodiment of a mold 500 is shown in an exploded view. Mold 500 includes base plate molds 510, side molds 520, outside mold 530, and inside mold 540. Outside mold 530 is a female mold for the “street” side of the wheel, while inside mold 540 is a female mold for the “drum” side of the wheel. Outside mold 530 and inside mold 540 provide forms to shape the features of the desired finished wheel design. Base plate molds 510 and side molds 520 provide an enclosed structure in which to infuse resin. The parts of mold 500 may be fabricated from typical mold materials such as aluminum, wood, steel, foam, or composites.

FIG. 8 shows an exemplary manufacturing system 600 in which mold 500 may be used. In addition to components of mold 500, system 600 comprises resin source 610, resin reservoir 620, vacuum pump 630, resin feeding tubing 640, inline resin tubing 650, exit resin tubing 660, resin reservoir inline 670, and vacuum tubing 680. Also shown in FIG. 8 is disc core 690, to be embedded inside a wheel. Base plate mold 510 is the base of the closed mold and is joined to the resin feeding tubing 640 or exit resin tubing 660, and to the rest of the pieces of the closed mold. Vacuum pump 630 is used to infuse resin from resin source 610 into the system at the necessary pressure. Resin reservoir 620 is connected to the vacuum pump 630 and collects excess resin from the system 600. The purpose of the reservoir 620 is to prevent resin from reaching the vacuum pump 630 and damaging it.

In operation, the outside mold 530 and inside mold 540 may first be coated with release agent. The disc core 690 and an optional rim core are sandwiched between layers of composite fiber such as carbon fiber, aramid, or fiberglass, and placed between outside mold 530 and inside mold 540. As described previously, disc core 690 may be integral with the rim core, or the rim core may be a separate piece and be comprised itself of separate components such as a bead seat insert. Additional layers of composite fiber are wrapped around the sandwiched core and around the forms of outside mold 530 and of inside 540, thereby embedding the core and forming the desired shape of the wheel as a single piece. Multiple layers of composite fiber may be laid in varying orientations to add strength to the wheel. Vacuum may be applied while laying the fibers to assist in conforming the layers to the details of the molds. Alignment fixtures may be used to ensure concentricity between the various mold components. The mold is then sealed from all directions, resin is pumped into the mold, and excess resin is subsequently removed. Possible resins include but are not limited to thermosetting resins such as epoxy, polyester, and vinylester. The material in the mold is allowed to cure under conditions appropriate for the particular resin. The curing process can be accelerated using heat such as in an oven or an autoclave. The wheel is then removed from the mold, trimmed, sanded, clear-coated, and lug nut inserts added if applicable.

Note that variations on the molds and apparatus of FIGS. 7 and 8 are possible for producing the composite wheel of the present invention. For instance, the base plates and side molds may be replaced by different configurations of mold enclosures as known in the art. Alternate resin pump and tubing equipment as used in the industry may be substituted for the system 600 of FIG. 8. Furthermore, although the disclosure describes wheels on which a tire will be mounted, the invention may also be applied to non-pneumatic wheels.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those of ordinary skill in the art, without departing from the spirit and scope of the present invention, which is more particularly set forth in the appended claims. Furthermore, those of ordinary skill in the art will appreciate that the foregoing description is by way of example only, and is not intended to limit the invention. Thus, it is intended that the present subject matter covers such modifications and variations as come within the scope of the appended claims and their equivalents.

What is claimed is:

1. A one-piece composite wheel, comprising:
a disc having an embedded disc core; and
a rim having an embedded rim core, the rim being integral with the disc;
wherein the disc core and the rim core comprise a reinforced honeycomb structure, and the disc and the rim comprise a composite material.

2. The wheel of claim 1 wherein the reinforced honeycomb structure comprises aluminum.

3. The wheel of claim 1 wherein the reinforced honeycomb structure comprises Trussgrid™ three-dimensional honeycomb.

4. The wheel of claim 1 wherein the disc comprises a hub section and spokes; and wherein the disc core corresponds to the shape of the hub section and spokes.

5. The wheel of claim 1 wherein the composite material comprises carbon fibers.

6. The wheel of claim 1 wherein the fibers are laid in multiple layers; and wherein the layers are laid in varying orientations.

7. The wheel of claim 1 wherein the disc core and the rim core are integral with each other.

8. The wheel of claim 1 wherein the rim core comprises two pieces.

9. The wheel of claim 8 wherein the rim core comprises a bead seat insert.

10. The wheel of claim 1 further comprising lug nut inserts in the disc.

11. A method of forming a one-piece composite wheel comprising the steps of:
placing a reinforced honeycomb disc core and a reinforced honeycomb rim core within a mold;
layering fiber around the disc core and around the rim core; and
infusing resin into the mold;
wherein the disc and the rim of the composite wheel are formed integrally with each other.

12. The method of claim 11 wherein the reinforced honeycomb comprises aluminum.

13. The method of claim 11 wherein the reinforced honeycomb comprises Trussgrid™ three-dimensional honeycomb.

14. The method of claim 11 wherein the fiber comprises carbon fiber.

15. The method of claim 11 wherein the step of layering comprises multiple layers of fibers in varying orientations.

16. A one-piece composite wheel, comprising:
a disc having an embedded disc core, the disc core comprising a reinforced honeycomb material; and
a rim, the rim being integral with the disc;
wherein the disc and the rim comprise a composite material.

17. The wheel of claim 16 wherein the reinforced honeycomb material comprises aluminum.

18. The wheel of claim 16 wherein the reinforced honeycomb material comprises Trussgrid™ three-dimensional honeycomb.

19. The wheel of claim 16 wherein the composite material comprises carbon fibers.

20. The wheel of claim 16 further comprising a bead seat insert.
